(19) United States
(12) Patent Application Publication
(10) Pub. No.: US 2007/0253206 A1
(43) Pub. Date: Nov. 1, 2007

(54) Lamp device with rotatable legs

(76) Inventor: Meiric Chen, Taiwan Hsien (TW)

Correspondence Address: Meiric Chen, Box 8-24, 235 Chung-Ho, Taipei, TW

(21) Appl. No.: 11/410,993

(22) Filed: Apr. 26, 2006

(51) Int. Cl. F21S 8/08

(52) U.S. Cl. 362/418; 362/449; 362/450

(57) ABSTRACT

A lamp device with rotatable legs comprises a lamp body having at least one stand rod; a light emitting unit combined to one end of the stand rod, and a lampshade; a lamp frame connected to one end of the lamp body; the lamp frame having a plurality of leg elements, a rotary unit and one positioning unit; the rotary unit having a plurality of axial rings; the number of the axial rings being identical to that of the legs; each axial ring being combined with a respective leg; the axial rings being connected one by one and then being combined to a lower end of the stand rod; and each of the axial rings having a respective positioning portion so that the axial rings being detachably combined one by one.

### FIELD OF THE INVENTION

The present invention relates to lamp frames, and particularly to a lamp device with rotatable legs, wherein the legs of the lamp device can be rotated to a state with a lower volume for storage and transfer. Furthermore, the legs can be expanded for supporting the lamp device in use.

### BACKGROUND OF THE INVENTION

The current lamp device, such as a stand lamp or a table lamp, has a lamp seat. The lamp seat is generally a leg frame. One side of the stand rod is combined to the lamp seat. Then a lamp and a lampshade are combined to another side of the stand rod. However in the prior art, the lamp seat has a fixed type structure. Although in some assembled lamp devices, the elements of the lamp devices are assembled for use, after assembly, the lamp devices have fixed type, which is unchangeable and unfoldable. Thus it is inconvenient to transfer and storage the lamp devices if they are assembled. It is often that the lamp devices are detached for transfer and storage. Then they are reassembled for use. This is time and labor consumed.

### SUMMARY OF THE INVENTION

Accordingly, the primary object of the present invention is to provide a lamp device with rotatable legs, wherein the legs of the lamp device can be rotated to a state with a lower volume for storage and transfer. Furthermore, the legs can be expanded for supporting the lamp device in use.

To achieve above objects, the present invention provides a lamp device with rotatable legs comprises a lamp body having at least one stand rod; a light emitting unit combined to one end of the stand rod, and a lampshade; a lamp frame connected to one end of the lamp body; the lamp frame having a plurality of leg elements, a rotary unit and one positioning unit; the rotary unit having a plurality of axial rings; the number of the axial rings being identical to that of the legs; each axial ring being combined with a respective leg; the axial rings being connected one by one and then being combined to a lower end of the stand rod; each of the axial rings having a respective positioning portions so that the axial rings being detachably combined one by one; and a stud passing through center holes of the axial rings and then being screwed into a threaded ring and then screwed into a hole of the stand rod; an upper side of the threaded ring being locked to the stand rod; thereby the axial rings being locked to the stand rod. Thereby the axial rings are rotatable along the stud.

The various objects and advantages of the present invention will be more readily understood from the following detailed description when read in conjunction with the appended drawing.

### BRIEF DESCRIPTION OF THE DRAWINGS

FIG. 1 is a schematic perspective view of the first embodiment of the present invention.

FIG. 2 is an exploded schematic view of the first embodiment of the present invention.

FIG. 3 is an assembled cross sectional view of the first embodiment of the present invention.

FIG. 4 is a schematic view showing the operation of the present invention.

FIG. 5 shows the second embodiment of the present invention which is in a state for transfer and storage.

FIG. 6 shows the second embodiment of the present invention, which is in a state for use.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

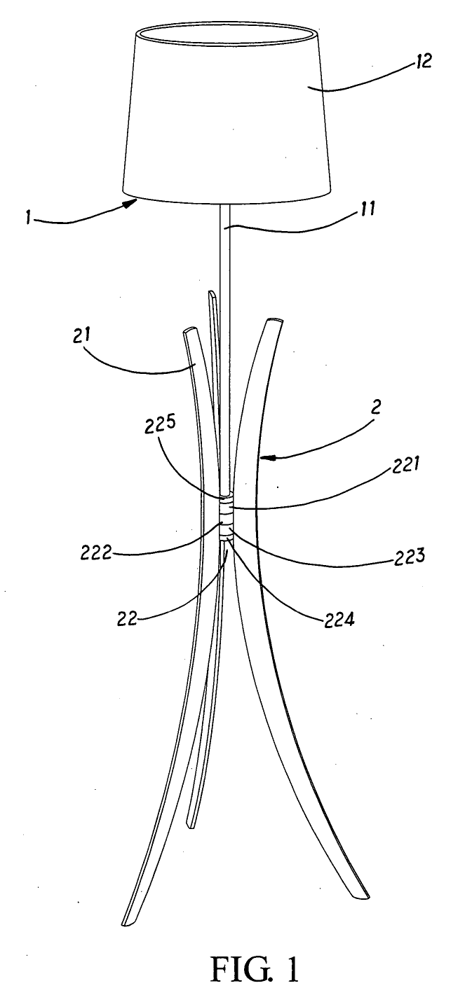

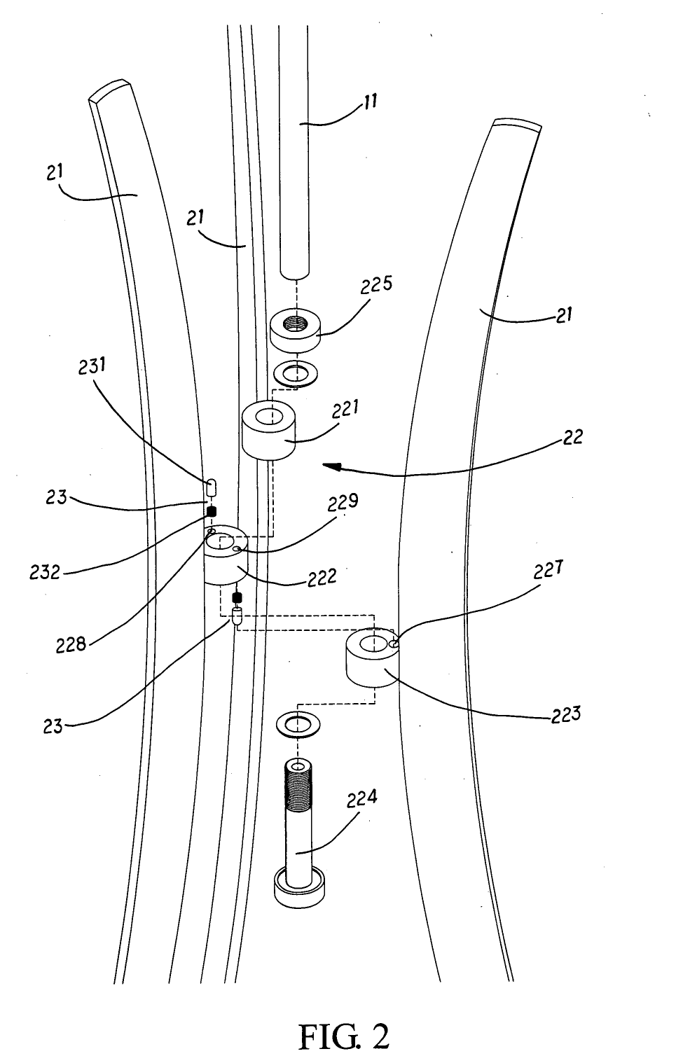

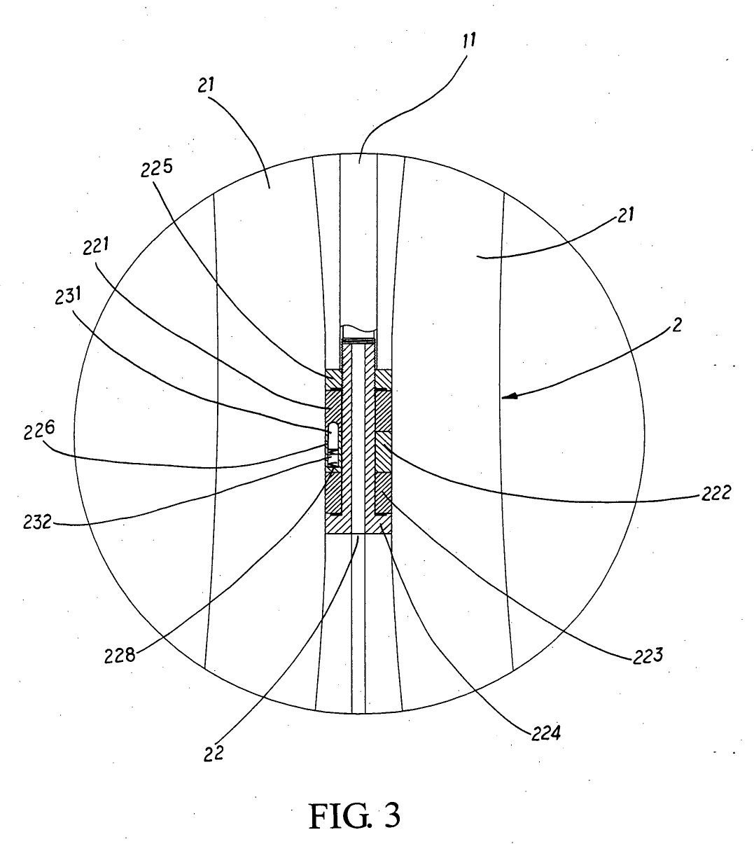

Referring to FIGS. 1 to 4, the present invention is illustrated. The present invention has the following elements.

The lamp supporter of the present invention can be expanded and folded easily and conveniently. The present invention is cheap.

A lamp body 1 includes at least one stand rod 11, a light emitting unit (not shown) combined to one end of the stand rod 11, and a lampshade 12.

The forms and shapes of the stand rod 11 and the lampshade 12 are not confined to above mentioned structures. Other forms and shapes are permissible.

A lamp frame 2 is connected to one end of the lamp body 1. The lamp frame 2 has a plurality of leg elements 21, a rotary unit 22 and one positioning unit 23.

The rotary unit 22 has a plurality of axial rings 221, 222, 223. The number of the axial rings are identical to that of the legs 21. Each axial ring is combined with a respective leg 21.

Then the axial rings 221, 222 and 223 are connected one by one and then are combined to a lower end of the stand rod 11. Each of the axial rings 221, 223 has a respective positioning portion 226, 227 each of which may be a recess or a hole for combining to the stand rod 11. The axial ring 222 has two assembly holes 228, 229 at two end surfaces thereof. Each assembly hole 228, 229 receives with a positioning unit 23. The positioning unit 23 is also received into the positioning portion 226, 227 so as to combine the axial ring 222 to the axial rings 221, 223. Each positioning unit 23 is formed by a buckle 231 and an elastic unit 232.

In assembly, a stud 224 passes through center holes of the axial rings 221, 222, 223 and then is screwed into a threaded ring 225 and then into a hole the stand rod 11. The upper side of the threaded ring 225 is locked to the stand rod 11. Thereby the axial rings 221, 222, and 223 are locked to the stand rod 11. A washer can be installed between the axial ring 223 and the stud 223 and another washer is installed between the axial ring 221 and the thread ring 225. Thereby the axial rings 221, 222 and 223 are rotatable along the stud 224.

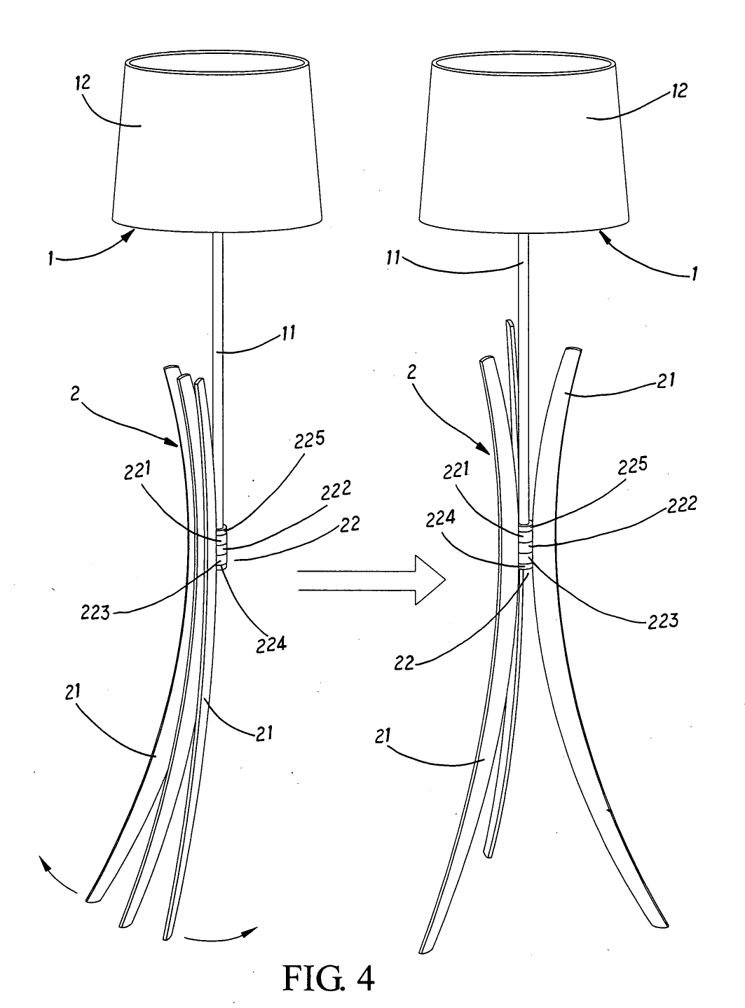

Referring to FIG. 4, the stud is released so that the positioning units 23 cannot confine the respective positions of the axial rings 221, 222, and 223. Then the axial rings 221, 222 and 223 can be rotated to be at one side so as to reduce the volume of the lamp structure for storage and transfer. In use, it is only necessary to expand the axial rings 221, 222 and 223 to predetermined positions so that the positioning units 23 can combine the axial rings 221, 222, and 223. Thus the lamp structure is retained in a fix position for use.

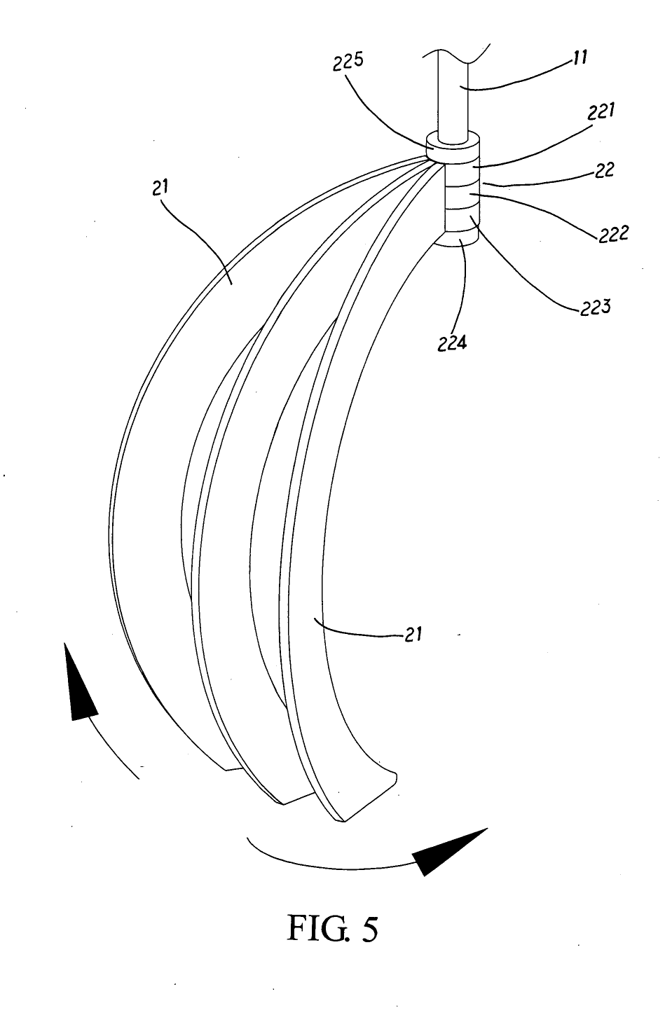

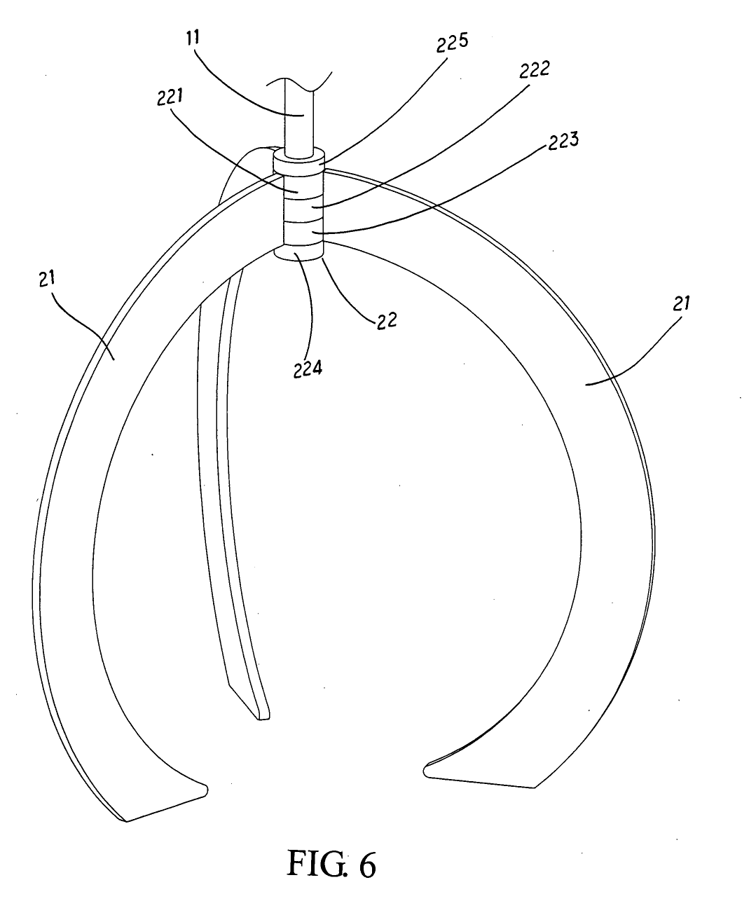

With reference to FIGS. 5 and 6, another embodiment of the present invention is illustrated. Those identical to the first embodiment will not be described. Only those differences are described. In this the present invention, the axial rings 221, 222 and 223 are combined to end portions of the legs 23. However it can present the same function as those described in the first embodiment.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A lamp device with rotatable legs comprising;
a lamp body having at least one stand rod; a light emitting unit combined to one end of the stand rod, and a lampshade;
a lamp frame connected to one end of the lamp body; the lamp frame having a plurality of leg elements, a rotary unit and one positioning unit;
the rotary unit having a plurality of axial rings; the number of the axial rings being identical to that of the legs; each axial ring being combined with a respective leg; the axial rings being connected one by one and then being combined to a lower end of the stand rod; each of the axial rings having a respective positioning portion so that the axial rings being detachably combined one by one; and
a stud passing through center holes of the axial rings and then being screwed into a threaded ring and then screwed into a hole of the stand rod; an upper side of the threaded ring being locked to the stand rod; the axial rings being locked to the stand rod; thereby the axial rings being rotatable along the stud.

2. The lamp device with rotatable legs as claimed in claim 1, wherein each axial ring has one assembly hole; a positioning unit is received in the assembly holes of two adjacent axial rings for combining with another axial ring; when the stud is screwed to cause that the two adjacent axial rings are disengaged, the positioning unit is withdrawn from one of the assembly hole so that one axial ring can rotate with respect to another axial ring.

3. The lamp device with rotatable legs as claimed in claim 1, wherein each positioning unit is formed by a buckle and an elastic unit.

4. The lamp device with rotatable legs as claimed in claim 1, wherein a washer is installed between the axial ring and the stud and another washer is installed between the axial ring and the thread ring.

5. The lamp device with rotatable legs as claimed in claim 1, wherein each leg has a cambered shape, and the axial ring is connected to a middle portion of the leg.

6. The lamp device with rotatable legs as claimed in claim 1, wherein there are three legs and three axial rings.

7. The lamp device with rotatable legs as claimed in claim 1, wherein each leg has a cambered shape and the axial ring is connected to one distal end of the leg.

8. The lamp device with rotatable legs as claimed in claim 1, wherein each leg has a cambered shape and the axial ring is connected to a middle portion of the leg.
